(19) United States
(12) Patent Application Publication
(10) Pub. No.: US 2014/0030400 A1
(43) Pub. Date: Jan. 30, 2014

(54) Process for Preparing Fruit Arrangements utilizing Coated Pineapple

(71) Applicants: Tariq Farid, North Haven, CT (US); Cynthia Mockler, North Haven, CT (US); Kristy Ferguson, Wallingford, CT (US)

(72) Inventors: Tariq Farid, North Haven, CT (US); Cynthia Mockler, North Haven, CT (US); Kristy Ferguson, Wallingford, CT (US)

(21) Appl. No.: 13/558,400

(22) Filed: Jul. 26, 2012

(51) Int. Cl. A23G 1/48; A23P 1/10; A23P 1/08

(52) U.S. Cl. 426/306

(57) ABSTRACT

A process for preparing a pineapple confectionary item for a fruit arrangement comprising the steps of: providing a piece of sectioned pineapple having pineapple meat and core intact; cutting the sectioned pineapple into a desired shape utilizing a shape cutter with the shaped pineapple having a first portion and a second portion. Once the pineapple is shaped, a skewer channel is created within the pineapple meat and core. Once the skewer channel is created, a coating of dark chocolate is applied to the first portion. A skewer is subsequently inserted into the skewer channel and the dark chocolate layer is allowed to cool. Once the dark chocolate is cooled, a coating of white chocolate is applied to the second portion; and subsequently allowed to cool.

### FIELD OF INVENTION

The present invention relates to the industry which prepares fruit arrangements for special occasions.

### BACKGROUND

The creation of fruit into decorative arrangements has been pioneered by Edible Arrangements, Inc. These arrangements are colorful, festive and appealing to the eye. By being comprised of fruit, they are also edible and fun to experience. These arrangements have become extremely popular as a substitute for floral arrangements given for special occasions such as holidays, Valentine's Day, birthdays and the like. However, these arrangements are more than a “fruit basket” comprising an assembly of fruit, such arrangements have special appearances which mimic flowers such as daisies and the like. These clever designs present an eye appeal which renders the arrangements as fruit representing art.

The preparation of the fruit into suitable configurations for assembly into arrangements has become a specialized task. Many hours of creativity has been required in order to develop methods of processing fruit which can be done in a manner which is easily replicated for consistent application among franchisees of such business for maintaining the good will of the business.

While prior fruit arrangements have become very popular, a need constantly arises for newer designs which will appeal to the masses both visually and in taste.

Accordingly, it is an object of the present invention to provide for an innovative method of preparing a pineapple for incorporation into a fruit arrangement.

### SUMMARY

A process for preparing a fruit for a fruit arrangement includes providing a sectioned pineapple meat with the core present. Then establishing a skewer channel within the pineapple meat and core. Once the skewer channel is established, applying a first coating of chocolate to a first portion of the sectioned pineapple meat. Then inserting a skewer into the skewer channel and applying a second coating of chocolate to a second portion of said pineapple meat.

### BRIEF DESCRIPTION OF THE DRAWINGS

For a fuller understanding of the invention, reference should be made to the following detailed description, taken in connection with the accompanying drawings, which are not drawn to scale, in which:

FIG. 1 illustrates the process for preparing a pineapple for a fruit arrangement according to the present invention.

FIG. 2 is a prospective view of a cutter utilized for cutting a particular design of the preferred embodiment wherein the pineapple has an appearance of a cupcake.

FIG. 3 is an illustration of an individual cutting a pineapple into a cupcake design utilizing a cutter.

FIG. 4 is a bottom view of a pineapple prepared according to the present invention having a skewer channel defined within the bottom of the pineapple.

FIG. 5 is an illustration of the bottom portion of the pineapple being dipped in a coating without a skewer in position.

FIG. 6 is an illustration of a plurality of pineapples coated with a first and second coating positioned within a container utilizing skewers.

### DETAILED DESCRIPTION

As required, exemplary embodiments of the present invention are disclosed herein. These embodiments are meant to be examples of various ways of implementing the invention and it will be understood that the invention may be embodied in alternative forms. The figures are not to scale and some features may be exaggerated or minimized to show details of particular elements, while related elements may have been eliminated to prevent obscuring novel aspects. Therefore, specific structural and functional details disclosed herein are not to be interpreted as limiting, but merely as a basis for the claims and as a representative basis for teaching one skilled in the art to variously employ the present invention.

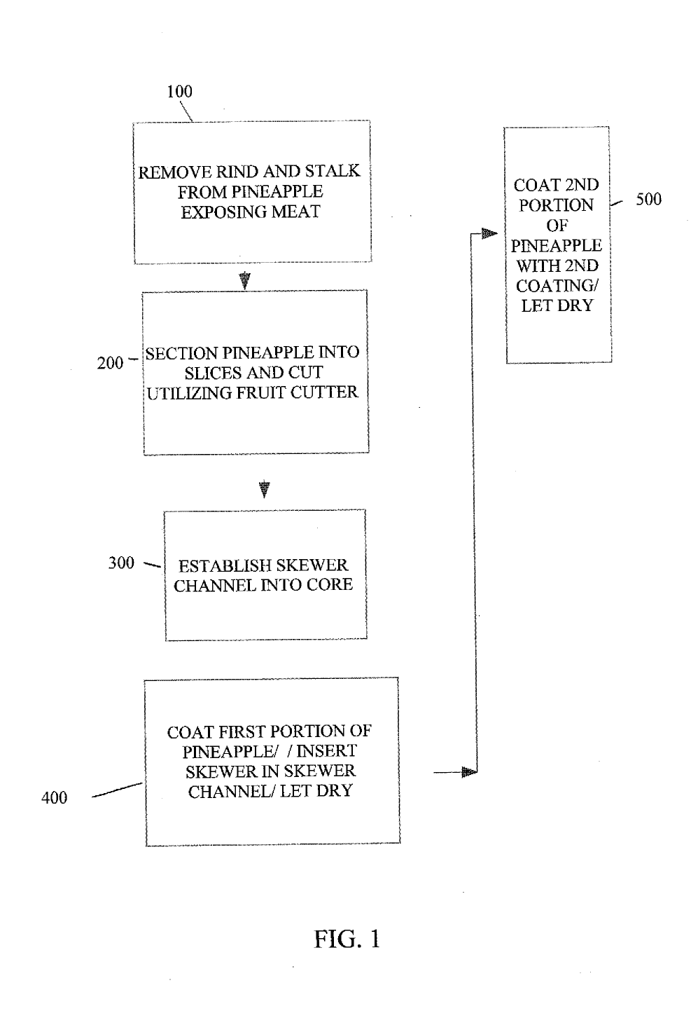

As shown in FIG. 1, processing pineapples requires that the prickly rind be removed exposing the meat of the fruit. This typically requires removing the stalk of the pineapple. This is done at step 100. After the stalk is removed, a portion of the top and bottom is removed. With these portions removed, the skin or rind is removed exposing the central meat of the fruit and core. The central core of the pineapple is typically very hard, fibrous and tough to chew, and consequently is typically removed. However, the present invention retains the core for subsequent utilization.

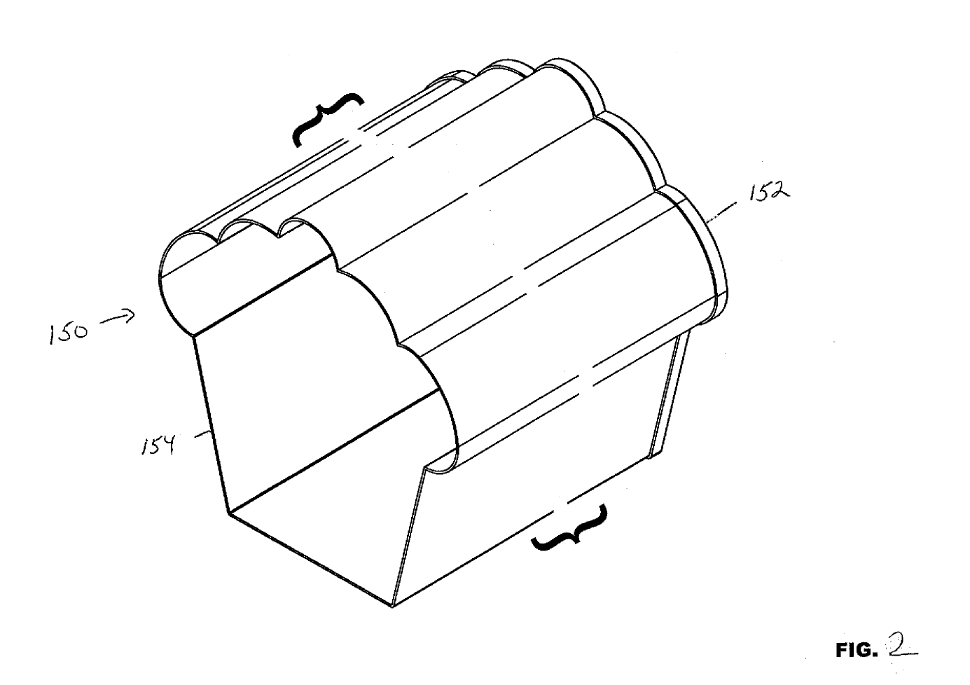

Once the meat of the pineapple with the core is provided, the meat is sectioned into slices of preferred thicknesses. In the preferred embodiment, as shown in FIG. 2, a cutter is utilized for cutting the meat at step 200. The cutter may be of any indeterminable length depending on the design. For instance, a cutter for only cutting a single section of pineapple would have a limited length, however if multiple sections are desired to be cut in the same pattern, the cutter would have a longer length to accommodate the multiple sections of pineapple. The fruit cutter is shaped like a cupcake having a planar base with a multi-arched crown opposite the planar base. A linear transition exists between the base and the arched crown which will be detailed during subsequent processing such that the base will resemble a cupcake holder with the profile of the “cupcake” being exposed above the cupcake holder.

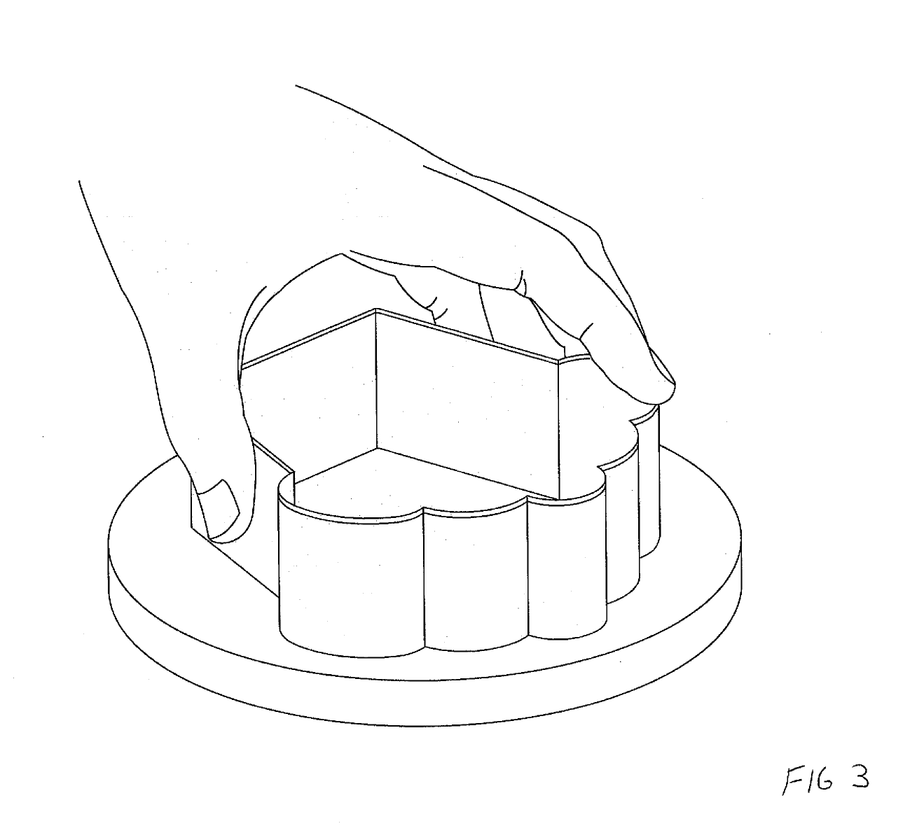

The fruit cutter has a bottom portion 152 for positioning the palm of a hand into the cutter and an opposite cutting edge 154. FIG. 3 illustrates a person positioning the pineapple cutter into place on a sectioned piece of pineapple.

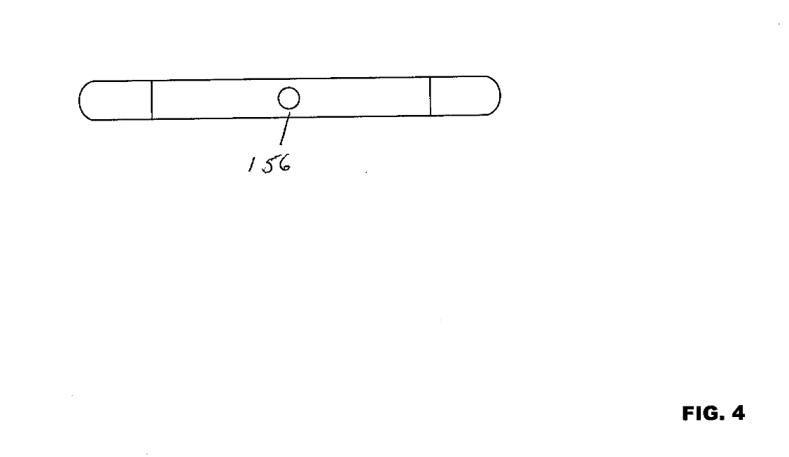

Once the pineapple meat with the core has been cut into the desired shape, a channel in the pineapple is created for subsequent receipt of a skewer for positioning the pineapple cupcake in a vertical secured position within an arrangement. The creation of the channel is established at step 300 by inserting a skewer through the base of the pineapple meat, through the meat and into the core of the pineapple. This forms the channel all the way into the core of the pineapple. Such construction is important in that the rigidness of the pineapple's core will provide stability for the cupcake when positioned within a fruit arrangement. Once the channel is defined, the skewer is removed in order to enable further processing of the pineapple. FIG. 4 illustrates the skewer channel 156 formed in the base of the pineapple cupcake.

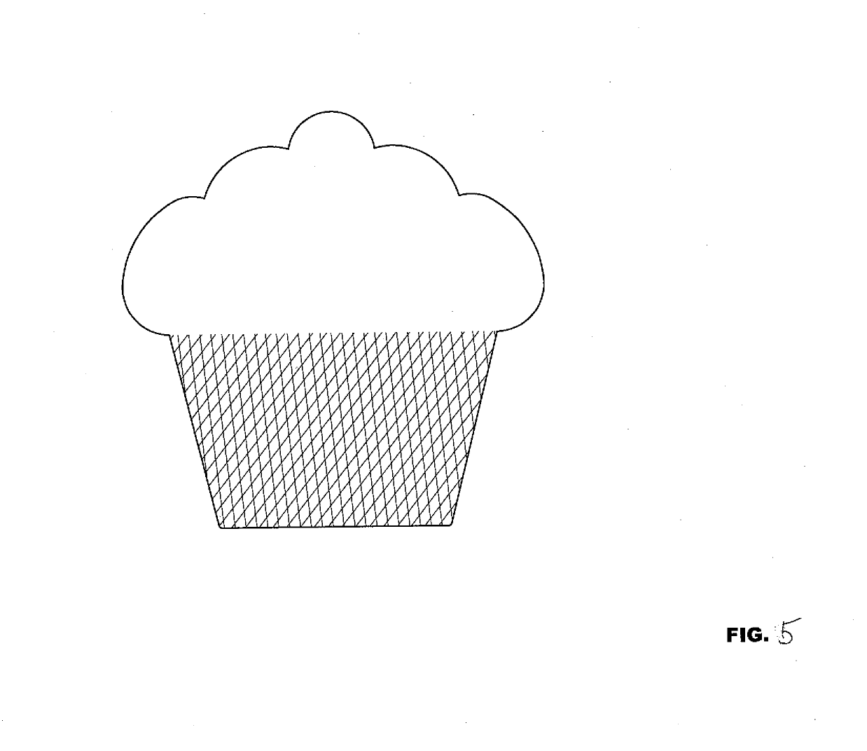

Once the channel has been defined within the interior of the pineapple, a first portion of the pineapple is dipped into a vat of a desired coating at step 400. In the preferred embodiment a cone dip warmer from Server, www.server-products.com, is utilized for retaining melted dark chocolate for dipping. In the preferred embodiment the pineapple is held by the crown portion with the skewer removed such that the base of the “cupcake” may be dipped into the cone tip warmer such that the base portion of the cupcake may be covered in the dark chocolate. FIG. 5 illustrates the lower portion of the cupcake pineapple being coated with a dark chocolate.

After the base has been dipped in the chocolate, the pineapple is removed and the skewer is inserted back into the skewer channel and into the core of the pineapple. In the dipping process it is desired that the dark chocolate enter into the skewer channel and pervade throughout the channel all the way into the core. With the wet chocolate in the core, the skewer is inserted into the skewer channel and as the dark chocolate is allowed to cool the chocolate within the skewer channel will bind onto the skewer and the interior of the pineapple providing a secure connection between the skewer and the pineapple. With the skewer in place, the pineapple is set aside to enable the dark chocolate to cool.

The establishment of a skewer channel prior to the initial dipping of an initial coating on the pineapple has been determined critical by the inventors. In order to provide a double coating on the pineapple, the initial coating must be done with the skewer disengaged from the pineapple in order to allow the portion of the pineapple which will eventually engage the skewer to be coated. Having the skewer in place would result in the skewer being submersed in the coating creating an unacceptable mess. Accordingly, the absence of a skewer during the initial coating of the base is required. However, with the coating of the base of the pineapple cupcake being applied, subsequent attempts of positioning a skewer into the meat and core of the pineapple without a pre-established skewer channel requires extensive force in order to penetrate the core. While the application of such force is possible if the pineapple section was placed on a flat table top, having the wet coating present on the pineapple results in the wet coating being smudged onto the flat table top establishing a messy working area, a waste of dipping product, and a non-uniform appearance on the pineapple cupcake with the possibility of certain uncoated areas being established. Hence, the establishment of a skewer channel prior to the coating of the base of the product is essential.

As shown in FIG. 1, once the initial dipped coating has cooled and solidified onto the pineapple cupcake, a second coating is applied to the upper crown portion at step 500. In the preferred embodiment with the skewer in place, the skewer is held by the operator who positions the crown of the pineapple cupcake into a second dipping station for a second dipped coating to be applied.

In the preferred embodiment, the second dipping station consists of white chocolate to provide a “frosting” appearance of the pineapple cupcake. The white chocolate in combination with the dark chocolate provides for a distinct two taste experience. The dark chocolate and pineapple provides for a zesty, chocolate experience while the white chocolate and pineapple provides for a pina colada taste. Additionally, the preferred sequence consists of applying the dark chocolate prior to applying the white chocolate. Dark chocolate has a melting point of approximately ninety-nine degrees Fahrenheit, while white chocolate has a melting point of eighty-four to eighty-seven degrees Fahrenheit. Accordingly, by applying the dark chocolate first and letting it cool and subsequently applying the melted white chocolate, should an overlap of the two chocolates occur at the transition point between the “base of the cupcake holder” and the “crown of the cupcake”, the white chocolate will merely overlap the dark chocolate while avoiding a re-melting of the dark chocolate and establishing a “marble” appearance.

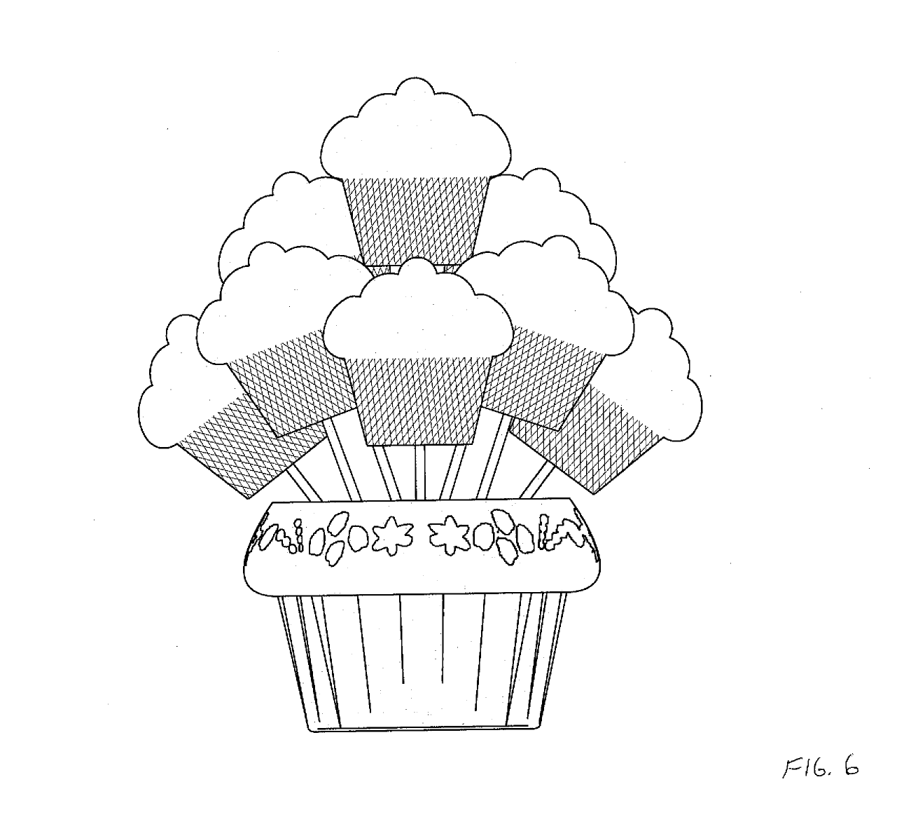

Once the second dipping coating is applied, the pineapple cupcake is removed and allowed to cool. If desired sprinkles may be applied to the wet white chocolate coating. Once the entire product is cooled, the pineapple cupcake with the skewer may be positioned within a fruit arrangement. The skewer enables the pineapple cupcake to be positioned in a container having foam and the like and supporting the pineapple cupcake in an upright manner. FIG. 6 illustrates the pineapple cupcakes secured utilizing their respective skewers within a container resembling a cupcake. Typically the skewers are inserted into a foam substrate.

We claim:

1. A process for preparing a fruit for a fruit arrangement comprising;
providing a sectioned pineapple meat with the core present;
establishing a skewer channel within the pineapple meat and core;
applying a first coating of chocolate to a first portion of said sectioned pineapple meat;
inserting a skewer into said skewer channel; and
applying a second coating of chocolate to a second portion of said pineapple meat.

2. A process for preparing a pineapple confectionary item for a fruit arrangement comprising;
providing a piece of sectioned pineapple having pineapple meat and core intact;
cutting said sectioned pineapple into a desired shape utilizing a shape cutter, said shaped pineapple having a first portion and a second portion;
creating a skewer channel within the pineapple meat and core;
applying a coating of dark chocolate to said first portion;
inserting a skewer into said skewer channel;
allowing said dark chocolate layer to cool;
applying a coating of white chocolate to said second portion; and
allowing said white chocolate layer to cool.

3. The process of claim 2 wherein said dark chocolate is applied to a lower portion of the shaped pineapple and said white chocolate is applied to an upper portion of the shaped pineapple.

4. The process of claim 2 wherein said cutter cuts the sectioned pineapple into a lower portion having a planar base and an upper portion having an arched crown.

5. The process of claim 2 wherein said pineapple is positioned in a container utilizing the skewer to support said pineapple.

6. A method of making a fruit arrangement comprising;
providing a piece of sectioned pineapple having pineapple meat and core intact;
cutting said sectioned pineapple into a desired shape utilizing a shape cutter, said shaped pineapple having a first portion and a second portion;
creating a skewer channel within the pineapple meat and core;
applying a coating to the pineapple;
inserting a skewer into said skewer channel; and
allowing said coating to cool.

7. The method of claim 6 further including positioning said coated pineapple into a container utilizing said skewer engaging a foam support.
